(19) United States
(12) Patent Application Publication
(10) Pub. No.: US 2015/0228210 A1
(43) Pub. Date: Aug. 13, 2015

(54) OUTDOOR DECORATIVE DISPLAY

(71) Applicant: Robert Miller, Menomonee Falls, WI (US)

(72) Inventor: Robert Miller, Menomonee Falls, WI (US)

(21) Appl. No.: 14/178,528

(22) Filed: Feb. 12, 2014

(51) Int. Cl. G09F 13/00; G09F 23/00

(52) U.S. Cl. CPC G09F 13/00; G09F 23/00; G09F 2007/1804

(57) ABSTRACT

A display wrap for creating a display image comprising: a flexible display panel; a plurality of attachment clips, where the attachment clips secure the display wrap around a fixed object; a series of display images where the display images are shown on the flexible display panel; and a power supply where the power supply provides a connection for power to illuminate the display image. The display image may be created through an array of lighting and the fixed object may be either a tree trunk or a deck railing. The array of lighting may create a series of moving display images.

### BACKGROUND OF THE INVENTION

1. Field of Invention

The present invention relates to an outdoor decorative display panel that may be installed on a tree or other fixed object.

2. Description of Related Art

The ability to decorate trees and other landscape is limited to some aspects. Normally individuals have trees to add to the aesthetic beauty of their landscaping. The trees may be normally decorated for different holidays such as Christmas, where Christmas lights may be hung in a tree or in certain instances ornaments may be placed in trees for display. Trees also may be decorated for other celebratory occasions. In general, however most trees have limited means to decorate them beyond the typical holiday decorations. In certain instances individuals may desire further tree decoration in order to provide a unique landscaping experience.

### SUMMARY OF THE INVENTION

The present invention relates to a display wrap for creating a display image comprising: a flexible display panel; a plurality of attachment clips, where the attachment clips secure the display wrap around a fixed object; a series of display images where the display images are shown on the flexible display panel; and a power supply where the power supply provides a connection for power to illuminate the display image. The display image may be created through an array of lighting and the fixed object may be either a tree trunk or a deck railing. The array of lighting may create a series of moving display images.

### BRIEF DESCRIPTION OF DRAWINGS

FIG. 1 depicts a rear view of a display wrap in accordance with the present invention.

FIG. 2 depicts a front view of a display wrap in accordance with the present invention.

FIG. 3 depicts a sectional view of a display wrap position around a tree trunk.

FIG. 4 depicts a display wrap placed onto a wooden deck railing.

### DETAILED DESCRIPTION

The present invention relates to a display wrap that includes a display panel that is visible on one side of the display wrap. The display wrap is a flexible material that includes a displaying image where the displaying image may be illuminated with array of light. The lights create a visual display image for decorative purposes. The flexible material is suitable for wrapping the display wrapped around a tree trunk. Attachment clips are provided to attach the end portions of the display wrap and to secure the wrap around the tree trunk or other fixed object. Adjustable brackets may be used for spacing purposes between a tree trunk and the inner surface of the display wrap. The display wrap receives power through a typical power source such as an AC connection cord.

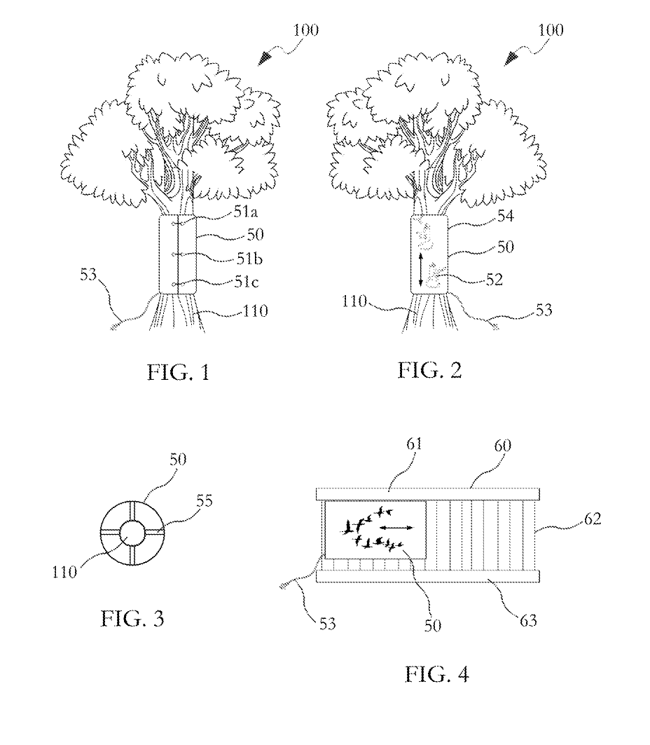

In reference to FIG. 1, a rear view of a Display Wrap 50 positioned around a Tree 100 as shown. The Display Wrap 50 includes a series of Connection Clips 51a, 51b and 51c. The

Connection Clips 51a, 51b, 51c secure the Display Wrap 50 around a Tree Trunk 110 as shown. A power cord 53 for the Display Wrap 50 may be connected to a AC power outlet to supply power to the display image provided on the Display Wrap 50.

FIG. 2 shows the front view of the Display Wrap 50. As shown, the Display Wrap 50 includes a Display Panel 54. On the Display Panel 54, a Display Image 52 is shown. In one particular embodiment, the images shown on the Display Panel 54 may create moving animals through an array of lighting that supports the image display shown on the Display Panel 54. FIG. 3 shows a cross-section of the Display Panel 54 as it is wrapped around the Tree Trunk 110. Brackets 55 may be used to adjust the diameter so that the Display Wrap 50 securely fits around various tree trunks regardless of size.

In an alternative embodiment shown in FIG. 4, the Display Wrap 50 is attached to a Deck Railing 60. As shown, the Deck Railing 60 includes a Top Rail 60 and a Bottom Rail 63 with a series of Support Posts 62 creating the complete support rail for a deck. The Display Wrap 50 is attached in between the Post 62 and therefore provides a wider display as opposed to a conventional tree attachment. This alternative embodiment creates another use for the Display Wrap 50 in accordance with the present invention.

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The exemplary embodiment was chosen and described in order to best explain the principles of the invention and its practical application, to thereby enable others skilled in the art to best utilize the invention and various embodiments with various modifications as are suited to the particular use contemplated.

What is claimed is:

1. A display wrap for creating a display image comprising:
a flexible display panel;
a plurality of attachment clips, where the attachment clips secure the display wrap around a fixed object;
a series of display images where the display images are shown on the flexible display panel; and
a power supply where the power supply provides a connection for power to illuminate the display image.

2. The display wrap according to claim 1 where the display image is created through an array of lighting.

3. The display wrap according to claim 1 where the fixed object includes at least one of a tree trunk and a deck railing.

4. The display wrap according to claim 2 where the array of lighting creates a series of moving display images.
